(19) United States
(12) Patent Application Publication
(10) Pub. No.: US 2018/0197214 A1
(43) Pub. Date: Jul. 12, 2018

(54) EFFICIENT, CENTRALIZED COMPUTER BASED TRANSACTION SYSTEM

(71) Applicants: Ghanshyam Rokde, Fremont, CA (US); Michael Sun, Livermore, CA (US); Swetha Devireddy, Austin, TX (US); Shih-Kang Chang, Dublin, CA (US); Ankush Singhai, Dublin, CA (US)

(72) Inventors: Ghanshyam Rokde, Fremont, CA (US); Michael Sun, Livermore, CA (US); Swetha Devireddy, Austin, TX (US); Shih-Kang Chang, Dublin, CA (US); Ankush Singhai, Dublin, CA (US)

(21) Appl. No.: 15/401,786

(22) Filed: Jan. 9, 2017

(51) Int. Cl. G06Q 30/04; G06F 17/30; G06Q 20/10; G06Q 40/02; G06Q 30/02

(52) U.S. Cl. CPC G06Q 30/04; G06F 17/30312; G06Q 30/0226; G06Q 40/02; G06Q 20/102

(57) ABSTRACT

An electronic payment platform is modified to support merchant loyalty programs by implementing a database and user interfaces for both merchant and consumer participation. As transactions are processed, the electronic payment platform evaluates each transaction to determine if the consumer, and more particularly the payment instrument used in the transaction, is registered. If so, and the merchant is currently offering an award based on satisfying certain criteria, the current transaction data is added to previous qualifying transactions to determine if an award should be granted. If so, the electronic payment platform manages distribution of funds to a designated payment instrument of the consumer.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Incentive plans depend on a consumer's presentation of a loyalty card when making a purchase. Further, a merchant is required to develop and host a technologically challenging rewards platform when attempting to create a loyalty program to improve customer purchase amount and frequency.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In some embodiments, an electronic payment platform hosts an electronic transaction monitoring system that allows a user such as a merchant to simply specify technical conditions for providing an award to a consumer and allow the electronic payment platform monitor electronic transactions made by consumers to determine when a registered consumer is eligible for a an electronic response such as an award. Rather than providing a discount on a future purchase or other soft award, the electronic payment platform may directly deposit cash or value back onto the customer's electronic payment instrument, such as a credit card. The electronic payment platform completes the award electronic transaction by drawing funds from an electronic merchant payment account. Neither the merchant nor the consumer are required to do anything beyond specifying the technical conditions for the award and registering one or more electronic payment cards, respectively. The electronic payment platform manages tracking qualifications, making appropriate electronic responses such as communicating awards, and collecting the award funds from the merchant. An electronic consumer portal may be provided that allows instant checking of progress towards achieving a desired response such as an award.

### BRIEF DESCRIPTION OF THE DRAWINGS

FIG. 1 illustrates a block diagram of system elements that may be present in a conditional value transfer system;

FIG. 2 is a block diagram illustrating an electronic payment platform, one of the system elements found in FIG. 1;

FIG. 3 is an illustration of a screen representing a user interface for configuring a merchant loyalty campaign;

FIG. 4 is an illustration of a first screen representing a user interface for a consumer application;

FIG. 5 is an illustration of a second screen representing another aspect of a user interface for the consumer application of FIG. 4; and

FIG. 6 is a flowchart of a method of performing conditional value transfer.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

A system is used to provide an electronic response such as an incentive to a consumer by a merchant. Unlike traditional electronic response programs such as merchant loyalty programs, the merchant does not need to develop and manage its own tracking and payout systems because an electronic payment platform downstream from the merchant administers all aspects of the loyalty program including monitoring consumer activity relative to qualifying for an electronic response such as an award and providing the award fulfillment when the consumer has satisfied the requirements. A portal manages both merchant and consumer interfaces for setting up rewards based on technical conditions and providing feedback to consumers regarding completion status.

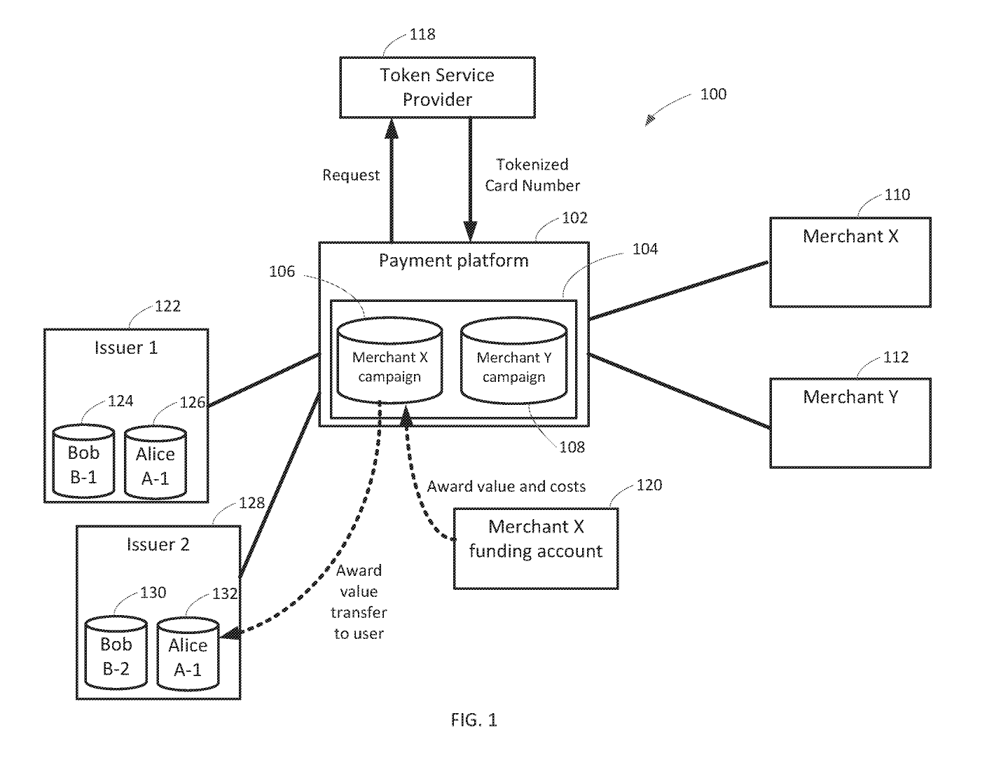

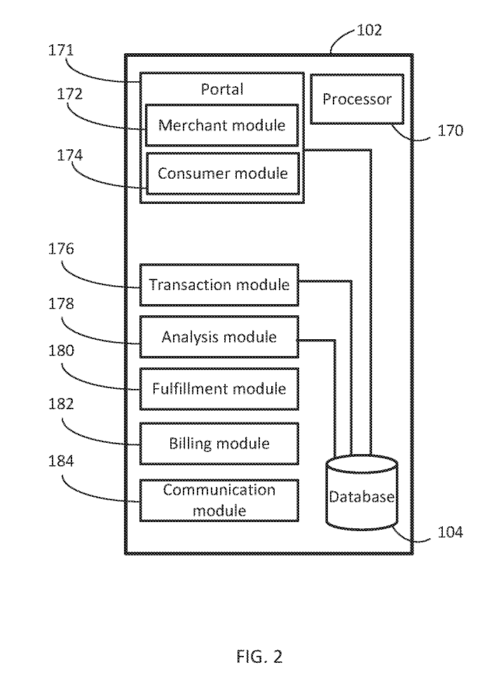

Referring to FIG. 1, a system 100 for use in providing conditional value transfers is illustrated. An electronic payment platform 102 is configured for conditional electronic response such as a transfer of value to a consumer. The electronic payment platform 102 allows a consumer to register to participate in the rewards program and then monitors participation in merchant-sponsored activities, including making purchases, that qualify the consumer to receive the electronic value. The electronic payment platform 102 is discussed in more detail below with respect to FIG. 2.

The system 100 may include the elements illustrated in FIG. 1, but in some embodiments, various components may not be present, or may be present in increased numbers to meet individual implementation requirements. The electronic payment platform 102 may include, among other elements, a database 104 hosting one or more campaign databases 106 and 108 related to loyalty campaigns. As illustrated in FIG. 1, campaign database 106 may support a campaign for merchant X 110 while another campaign database 108 may support another campaign associated with merchant Y 112. A campaign may be a set of technical conditions that result in electronic response to a user. There is no technological limit on how many campaigns an individual merchant may host at one time, nor is there a technological limit on how many different merchants can be hosted by the electronic payment platform 102. Unlike a traditional prior art electronic payment platform, the electronic payment platform 102 is modified to provide additional functions and services not previously found in a generic system.

In an aspect of the disclosure, a token service provider 118 may be used to provide greater security to transactions processed at the merchants, 110, 112, to the point of the merchants 110, 112 not knowing the identity of an individual consumer who may be participating in their loyalty programs. While this may seem contrary to the goals of a loyalty program, a system 100 implemented as described offers merchants a chance to influence purchasing behavior and provide direct access to the consumer for publicizing its campaigns through a consumer application. Similarly, the consumer may be able to benefit from the awards made available through loyalty campaigns without actually sharing personal details with the merchant or signing up with each merchant offering loyalty programs. This both protects the consumer's personal information including email accounts, as well as improving security for things like personal account number (PAN) data for various payment instruments because this information is not necessarily shared with the merchant. These and other aspects of the disclosure are discussed in more detail below.

FIG. 1 also illustrates that the electronic payment platform 102 may be connected to one or more issuers 122, 128 in a conventional manner. The issuers 122, 128 have details for payment instruments 124, 126, 130, 132 for various consumers. These payment instruments 124, 126, 130, 132 may be eligible for registration for participation in any loyalty campaigns offered by one more merchants 110, 112. A merchant funding account 120 may be used by the electronic payment platform 102 for providing award amounts to consumers who meet the conditions for an award and also for paying costs associated with the loyalty campaign.

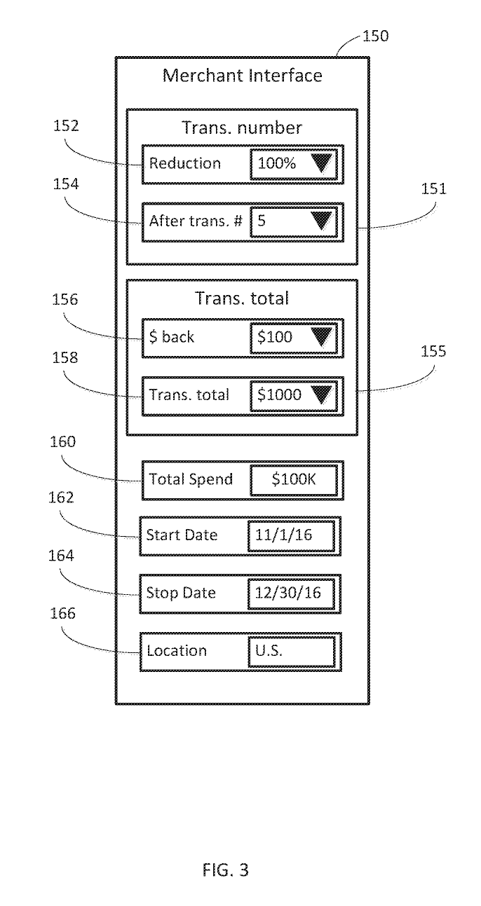

The electronic payment platform 102 is illustrated in more detail in FIG. 2. A processor 170 executes commands stored as various routines or modules. A portal 171 may be executable code used to support communications for viewing options, inputting data, checking status, and receiving notifications related to campaigns, both for merchants 110, 112 as well as consumers. The portal 171 may include a merchant module 172 that receives conditions for providing an award to a consumer as well as settings and limits. Turning briefly to FIG. 3, an exemplary merchant interface 150 supported by the merchant module 172 may be depicted. A first selection block 151 may allow a merchant 110 to select one type of campaign involving a “buy n, get one free” scenario. Drop down 152 allows the merchant to select the amount of reduction in cost, while drop down 154 indicates the number of purchases required to get the free item, in this illustration, buy 5 get one free.

A second kind of campaign may be set up using a second selection block 155. This campaign awards cash back after a consumer spends a minimum amount over a period of time, for example. In this illustration, drop down 156 and drop down 158 specify that a consumer gets $100 after spending $1000. In the illustrated embodiment, these purchases are specified to occur between Nov. 1 and Dec. 30 of the year 2016. The campaign types illustrated in selection blocks 151 and 155 are merely illustrative of a virtually limitless number of combinations of purchases, store visits, purchase amounts, etc., that can be configured. Further, the number of fields required to specify a campaign may be increased to include various details related to the value of a free item or specifics on qualifying purchases.

Other fields may be supported for the definition of a campaign including a total spend amount 160 that defines the amount the merchant 110 will dedicate to the campaign, such that when the total spend amount 160 is exceeded, the campaign may end. A start date 162 and stop date 164 may define limits on the campaign, in combination with the total spend amount 160. A location value 166 may be used to specify geographic limits on a campaign, such as a country, an area code, a commerce region, etc. The merchant interface 150, as implemented in the merchant module 172 provides a merchant 110 a convenient way to set up and operate a loyalty campaign without the necessity to code and develop an in-house tool for monitoring transactions, recording client transactions, both on-line and in-store, and administering payouts and refunds when campaign criteria are met by a consumer. The electronic payment platform 102, from its vantage point of handling all transactions processed through to an issuer 122, 128 evaluates each approved transaction to determine whether the merchant 110 is current sponsoring a campaign, whether the consumer has registered the payment instrument, e.g., credit card, for participation in campaigns, and when those two things are true, evaluates the consumer's progress toward achieving an award via the campaign. The merchant may specify a specific nameplate or card brand, or may allow all of a consumer's registered payment instruments to participate in a campaign, providing flexibility for co-sponsored campaigns.

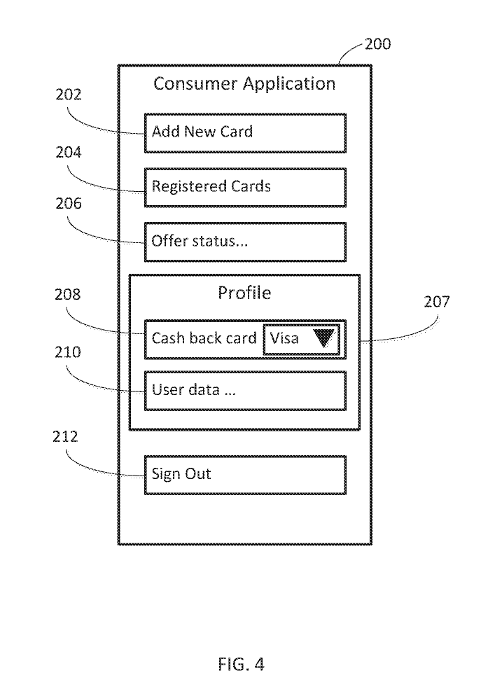

Returning to FIG. 2 before turning briefly to FIG. 4, the portal 171 may also include a consumer module 174 that supports consumer interactions related to a campaign, past, current, or proposed. FIG. 4 illustrates an exemplary home screen of a consumer application 200, such as may be hosted on a personal device, driven by data generated at the consumer module 174 of the portal 171. A home screen of a consumer application 200 may include various status and profile information available to a consumer, including fields for adding a card 202, reviewing registered cards 204, and checking the status of offers 206. A profile management area 207 may include a selection field 208 that allows a consumer to select a payment instrument, e.g., credit card, used to receive award value. A consumer data management field 210 may provide additional fields for entering or updating personal information, such as contact information and social media links. A sign-out field 212 may allow a consumer to exit the application and prevent others from viewing his or her settings and status prior to logging back in. In supporting the data for the consumer application, the consumer module 174 may have access to the database 104 for retrieving and updating consumer information, campaign offerings made by merchants, and current status of consumer achievements toward fulfilling various in-progress campaigns.

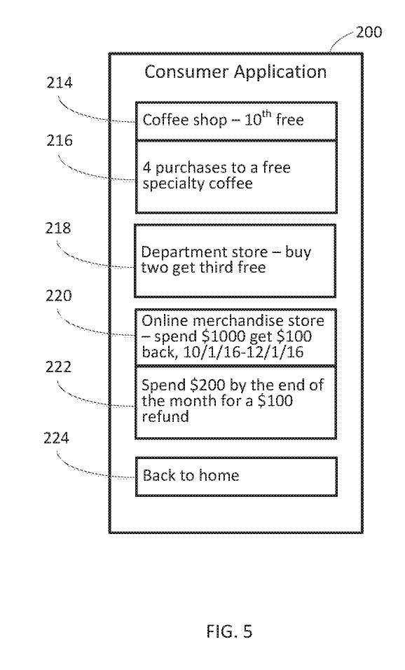

A further aspect of the consumer application 200 is illustrated in FIG. 5, showing a possible screen presented after selecting the offers option 206 of FIG. 4. A first offer 214 describes an offer from a coffee shop where the tenth purchase is free. A status field 216 shows that the consumer has partially fulfilled the conditions of the offer and has 4 additional purchases to make before receiving the free item. A second offer 218 describes a campaign sponsored by a department store for which the consumer has had no qualifying activity.

A third offer 220 from an online merchandise store provides for a $100 cash back after spending $1000 during a period of time. A status field 222 advises the consumer of what must be completed to fulfill the conditions of the offer. A return field 224 allows the consumer to return to the previous screen. The consumer application 200 may be the conduit through which a merchant can publicize campaigns and attempt to influence a consumer even when the identity of the consumer is hidden from the merchant. For example, the offers screen of FIG. 5 provides a conduit for communication with the consumer even though the consumer's identity with respect to campaign participation may not be known to the merchant 110.

Returning to FIG. 2, a database 104 stores merchant offer data and consumer data relative to loyalty campaigns. A transaction module 176 processes transactions of the merchant 110, 112 in a conventional manner as, for example, a merchant acquirer or a payment gateway for clearing transactions. An analysis module 178 may parse each transaction to extract the merchant and the payment instrument to determine first, if the merchant has an offer outstanding and if so, whether the card number that was used is registered by a consumer for use in loyalty campaigns. If both elements are true, the analysis module 178 may retrieve information from the database 104 to determine if the consumer is eligible for an award and/or updates the database 104 with the data related to the current transaction. The transaction module 176 may process transactions for multiple merchants 110, 112.

A fulfillment module 180 credits a value of the award to a financial instrument designated by the registered consumer when the conditions for an offer have been met. In an embodiment, an actual cash value of the award is transferred to the consumer, or more specifically, to a payment instrument designated by the consumer. In other embodiments, points, status, or merchandise may be made available to the consumer rather than a monetary only award.

A billing module 182 may be used to charge a value of the award to a funding account of the merchant. The billing module 182 may also calculate and include any fees associated with the campaign in general and with the fulfillment of individual awards specifically. In an embodiment, an operator of the electronic payment platform may charge a fixed percentage of the value of an award provided as compensation for operating the system on behalf of the merchant. In another embodiment, different fee structures may be used, such as a fixed fee based on a duration of a campaign and a percentage of the total spend.

A communication module 184 may manage network traffic and other performance-related capabilities such as load balancing, mirroring, etc. The architecture illustrated in FIG. 2 is merely one possible design and other architectures that may include cloud storage or distributed processing may be used. However, each of these architectures may include some form of the functions described above.

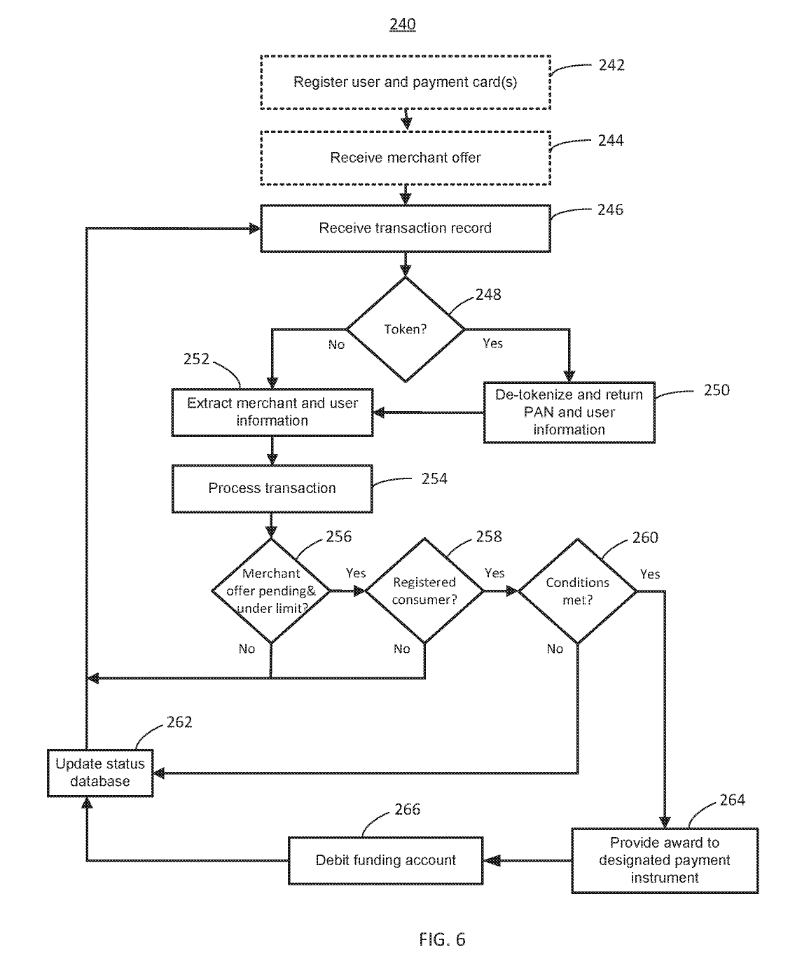

FIG. 6 is a flowchart of a method 240 for implementing conditional transfer of value based on a transaction history. At a block 242, an electronic payment platform 102 may receive registration data from a consumer, the registration data may include consumer identification information and one or more payment instruments to associate with the consumer. The consumer may subsequently referred to as a registered consumer. The registered consumer may also indicate a registered payment instruments to which award payments will be made. The process of registering payment instruments may include determining that a selected payment instrument is capable of receiving cash back, for example, using an original credit transfer. When the cash back function is not supported, the consumer may be encouraged to register a different payment instrument. In an embodiment, when a consumer uses an unregistered payment instrument for a transaction, an offer may be made at the point of sale, including a web session, for the consumer to register the payment instrument for use in the loyalty programs supported by the electronic payment platform.

At block 244 the electronic payment platform 102 may receive campaign data from a merchant 110. The campaign data may include conditions for any registered consumer to receive an award as well as a value of the award, as depicted for one embodiment in FIG. 3 as described above. The electronic payment platform 102 may be able support more than one campaign for an individual merchant 110 at a time. Similarly, the electronic payment platform 102 may support campaigns for multiple merchants 110, 112 at the same time.

The steps of blocks 242 and 244 may be repeated as few as one time, in the case of a consumer, and as few as once per campaign for a merchant. In an embodiment, the merchant may choose to update characteristics of the campaign after the initial definition. For example, the merchant 110 may wish to extend the time period for a particularly successful campaign and/or increase a total spend.

At block 246, transaction data may be received from the merchant 110. The transaction data may include an identification of a consumer and a payment instrument used for the transaction.

At block 248, the payment instrument may be evaluated to determine whether it is a tokenized card number. If so, execution continues at block 250 and the tokenized card number is passed to token service provider 118 in order to match the token to a payment instrument. In order to increase security in the process, the token service provider 118 may also provide confirmation of an identity of the consumer. Execution may continue at block 252 with either the personal account number (PAN) from the token service provider 118 or from the original transaction data received at block 246. At block 252, the merchant, user information, and transaction data may be extracted.

At block 254, the transaction may be processed for payment, for example, by passing the transaction data to an appropriate issuer 122. The electronic payment platform 102 may receive the transaction response and notify the merchant 110 of the status. Assuming the transaction is approved, execution may continue at block 256 where the electronic payment platform 102 inquires the database 104 to determine whether the merchant 110 has an offer pending. For example, the database 104 may contain information on a campaign 106 sponsored by the merchant 110. The electronic payment platform 102 may also determine whether a spend limit has been exceeded for the current campaign. If there is no offer pending, or a spend limit for a pending campaign has been exceeded the no branch may be taken from block 256 and execution continues at block 246 were another transaction record may be processed.

If a valid campaign is pending and there are available funds, execution and continue at block 258, where the payment instrument may be checked to determine whether the consumer, as identified by the payment instrument, is registered. If no, execution continues at block 246. If yes, execution may continue at block 262 determine if the consumer's previous transactions, in view of his or her current transaction, meet the conditions for an award under the current campaign. If no, execution continues at block 262 where updates to the consumer information in campaign database 106 may be recorded and execution continues at block 246.

If, at block 260 the conditions for a campaign have been met, the “yes” branch may be taken from block 260 to block 264 where an award in the amount specified by the campaign can be made to the designated payment instrument. In an embodiment, the award is a cash amount that is given directly to the consumer as a credit to his or her payment instrument. Execution may continue at block 266 where funds for the award may be taken from a merchant funding account 120. In an embodiment, rather than settling funds as each award is made, the award amounts may be accumulated and, for example, settled at the end of each business day. As discussed above, an amount greater than the actual award given to consumer may be transferred in order to cover contractual costs associated with administering a loyalty campaign as agreed to in a hosting agreement.

Execution may continue at block 262 where the campaign database 106 may be updated to indicate that the consumer has completed the campaign and an award has been granted. In various embodiments, the consumer may be able to continue working toward an additional award, while in other embodiments, the consumer may not be allowed to participate in a particular campaign more than once.

While the flow shown depicts the award evaluation more or less in real time compared to the transaction processing, in another embodiment, the transaction data may be stored and evaluated at a later time, for example, overnight when transaction processing volumes may be reduced.

The system and method solve the technical problem of creating and managing monitoring systems, controls, and databases for each merchant that wishes to participate in an incentive program. Instead, redundant systems are eliminated and a single point of contact is developed and maintained for merchants to administer their respective incentive programs without the added cost and technological investment in hardware and financial systems. The use of such a system benefits both merchants and consumers when simple, easy to use, and easy to operate systems are in place for engaging consumers.

1. A system for executing conditional transfer of value comprising:
a portal including a merchant module that receives conditions for providing an award to a consumer;
a transaction module that processes transactions of the merchant;
a database that stores the conditions, data of registered consumers, and transaction data from the merchant;
an analysis module that matches transactions by a registered consumer at the merchant to the conditions for providing the award;
a fulfillment module that, when the conditions are met, transfers a value of the award to a financial instrument designated by the registered consumer; and
a billing module that charges a value of the award to a funding account of the merchant.

2. The system of claim 1, further comprising a communication module that receives the transactions from the merchant.

3. The system of claim 2, wherein the communication module sends each of the transactions to an issuer for approval of a corresponding transaction received at the system.

4. The system of claim 1, wherein the merchant module provides an interface for receiving the conditions, a date range for a campaign, and a limit on total award spend for the campaign.

5. The system of claim 1, wherein the data of registered consumers includes one or more payment instruments associated with a registered consumer and a designation of a one payment instrument for receiving award value.

6. The system of claim 5, wherein the portal further comprises a consumer module that provides a consumer interface for receiving registration data and information for one or more payment instruments from the consumer.

7. The system of claim 6, wherein the consumer module provides data on available offers and progress toward reaching the conditions for receiving an award.

8. The system of claim 1, wherein the transaction module monitors transactions for a plurality of merchants.

9. The system of claim 1, wherein the conditions specify one of a number of transactions with the merchant or a cumulative value of one or more transactions with the merchant by the registered consumer.

10. A method of providing a conditional transfer of value based on a transaction history comprising:
receiving registration data from a consumer, the registration data including consumer identification information and one or more payment instruments to associate with the consumer, the consumer subsequently referred to as a registered consumer;
receiving campaign data from a merchant, the campaign data including conditions to be met for any registered consumer to receive an award and a value of the award;
receiving transaction data from the merchant, the transaction data including an identification of a consumer and a payment instrument used for the transaction,
determining that the consumer is the registered consumer;
determining that the payment instrument is one of the one or more payment instruments associated with the registered consumer;
accessing a database of transactions between the registered consumer and the merchant;
determining whether the transactions between the registered consumer and the merchant meet the conditions for the award; and
when the conditions are met, providing a direct deposit of a value of the award to a designated one of the one or more payment instruments associated with the consumer.

11. The method of claim 10, further comprising:
charging the value of the award to the merchant after providing the direct deposit of the value of the award to the designated one of the one or more payment instruments associated with the consumer.

12. The method of claim 10, wherein an unregistered consumer is offered an opportunity to register at a time of a transaction with the merchant.

13. The method of claim 10, wherein receiving registration data from the consumer comprises determining that the one or more payment instruments to associate with the consumer are capable of receiving the direct deposit of value.

14. A computer system for executing a conditional transfer of value comprising:
a server programmed to:
receive a transaction record corresponding to a transaction at a merchant, the transaction record including:
consumer data;
merchant data;
purchased item or service data; and
payment data comprising a payment instrument;
determine whether the payment instrument referenced in the transaction record is associated with a registered consumer according to the consumer data;
determine whether a merchant identified in the transaction record has made an offer based on a condition;
when the payment instrument is associated with a registered consumer and the merchant has made an offer based on the condition, analyze historical data for the registered consumer and the transaction record to determine that the condition is met;
when the condition is met, determine that a limit for the offer has not been exceeded;
in response to the limit for the offer not being exceeded, determine whether the merchant has funds available at a funding account;
transferring an amount of funds from the funding account to an account of the registered consumer according to the offer; and
communicate the transaction record to a payment clearing operation server.

15. The system of claim 14, further comprising:
a token service provider physically configured to receive the transaction record from the computer system;
analyze the transaction record including a tokenized card number;
match the tokenized card number with a personal account number (PAN) of the registered consumer; and
communicate a message to the computer system including the PAN and an confirmation of an identity of the registered consumer.

16. The system of claim 14, wherein the server is further programmed to transfer an amount of funds from the funding account to an account of an operator of the computer system according to a hosting agreement.

17. The system of claim 14, wherein the server is further programmed to determine that the merchant has funds available at the funding account prior to transferring the amount of funds to the account of the registered consumer.
